(19) United States
(12) Patent Application Publication
(10) Pub. No.: US 2026/0309502 A1
(43) Pub. Date: Oct. 8, 2026

(54) METHOD FOR DETERMINING OPTIMIZED BASIS FUNCTIONS FOR DESCRIBING TRAJECTORIES

(71) Applicant: Robert Bosch GmbH, Stuttgart (DE)

(72) Inventors: Philip Holzwarth, Stuttgart (DE); Andreas Herold, Aschaffenburg (DE); Markus Burkhardt, Kornwestheim (DE); Nico-Philipp Walz, Bad Friedrichshall (DE)

(21) Appl. No.: 19/710,678

(22) Filed: Jun. 17, 2026

Related U.S. Application Data
(63) Continuation of application No. 18/184,791, filed on Mar. 16, 2023.

(30) Foreign Application Priority Data
Mar. 21, 2022 (DE) 10 2022 202 718.3

(51) Int. Cl. G05D 1/00

(52) U.S. Cl. CPC G01C 21/20; B60W 60/001

(57) ABSTRACT

A method for determining optimized basis functions for describing trajectories. The method includes receiving reference data which describes possible trajectories; preprocessing the reference data, wherein the reference data is aggregated in a matrix Y; carrying out a singular value decomposition Y=USV^{T}, wherein the matrices U and V each comprise singular vectors and Sis a diagonal singular value matrix with singular values σᵢ; identifying at least one of the singular values σᵢ as a dominant singular value σ_{d,i} and at least one other of the singular values σᵢ as a non-dominant singular value σ_{nd,i}; and determining a matrix U_{d} which comprises dominant singular vectors assigned to the dominant singular values σ_{d,i}, wherein the optimized basis functions are described by the dominant singular vectors.

### CROSS REFERENCE

The present application is a continuation of U.S. patent application Ser. No. 18/184,791 filed on Mar. 16, 2023, which claims the benefit under 35 U.S.C. § 119 of German Patent Application No. DE 10 2022 202 718.3 filed on Mar. 21, 2022, each of which is expressly incorporated herein by reference in its entirety.

### FIELD

The present invention relates to computer-implemented methods for determining optimized basis functions for describing trajectories, a computer-implemented method for estimating trajectories and a computer-implemented method for controlling an actuation system of a vehicle. The present invention also relates to a data processing device and a computer program for carrying out at least one of these methods, as well as a computer-readable medium on which the computer program is stored.

### BACKGROUND INFORMATION

Optimization problems play a critical role in many algorithms related to driver assistance functions and automated driving. These include determining a driving task from raw sensor data and trajectory planning, for example.

An optimization problem is often formulated in such a way that the solution can be approximated in a subspace defined by specific basis functions. Such basis functions are typically selected on the basis of heuristic considerations. For the approximation of a line representing a lane marking, for instance, regulations such as the guidelines for the design of motorways (RAA), the guidelines for the design of rural roads (RAL) or the directives for the design of urban roads (RAS) can be used. From this it can then be deduced, at least in cases in which only the data in the immediate vicinity of the ego vehicle is relevant, for instance, that a low-order monomial basis is a sufficient approximation due to the clothoid curves that are typically used in the construction of roads.

### SUMMARY

Methods for determining optimized basis functions for describing trajectories, a method for estimating trajectories, a method for controlling an actuation system of a vehicle, a corresponding computer program and a corresponding computer-readable medium according to the present invention are provided. Advantageous developments and example embodiments of the present invention are disclosed herein.

Embodiments of the present invention make it possible to automatically determine optimal basis functions for a specific optimization problem by means of linear combination, such as may occur, for example, in the context of trajectory planning for driver assistance functions or automated driving.

A first aspect of the present invention relates to a computer-implemented method for determining optimized basis functions for describing trajectories. According to an example embodiment of the present invention, the method comprises at least the following steps: receiving reference data which describes possible trajectories; preprocessing the reference data, wherein the reference data is aggregated in a matrix Y; carrying out a singular value decomposition Y=USV^{T}, wherein the matrices U and V each comprise singular vectors and S is a diagonal singular value matrix with singular values σᵢ; identifying at least one of the singular values σᵢ as a dominant singular value σ_{d,i} and at least one other of the singular values σᵢ as a non-dominant singular value σ_{nd,i}; and determining a matrix U_{d} which comprises dominant singular vectors assigned to the dominant singular values σ_{d,i}, wherein the optimized basis functions are described by the dominant singular vectors.

A second aspect of the present invention relates to an alternative computer-implemented method for determining optimized basis functions for describing trajectories. According to an example embodiment of the present invention, the method comprises at least the following steps: receiving reference data which describes possible trajectories; preprocessing the reference data, wherein the reference data is aggregated in a matrix Y; aggregating predefined basis functions in a matrix A; carrying out a singular value decomposition P=(A^{T}A)⁻¹A^{T}Y=USV^{T}, wherein the matrices U and V each comprise singular vectors and S is a diagonal singular value matrix with singular values σᵢ; identifying at least one of the singular values σᵢ as a dominant singular value σ_{d,i} and at least one other of the singular values σᵢ as a non-dominant singular value σ_{nd,i}; and determining a matrix product AU_{d} by multiplying the matrix A by a matrix U_{d} which comprises dominant singular vectors assigned to the dominant singular values σ_{d,i}, wherein the optimized basis functions are described by the matrix product AU_{d}.

The reference data may have been abstracted from norms and regulations, for example, from customer requirements for specific driving maneuvers and/or from recorded and possibly preprocessed sensor data from test drives.

When preprocessing the reference data, it is possible to extract travel lanes, for example, as potential trajectories to be approximated. Among other things, the trajectories can be scaled, weighted and/or trimmed to a common length, e.g. “1”.

The matrix Y can contain coordinates of the possible trajectories to be approximated.

“Singular value decomposition” can generally be understood as an algorithm with which a m×n matrix Y can be expressed as the product of three matrices having specific structural properties. In the case of a real matrix Y:

$$Y = {USV}^{T} ;$$

wherein U can be an orthogonal m×m matrix, V an orthogonal n×n matrix and S a m×n diagonal matrix with non-negative entries. These entries can be sorted in descending order from top left to bottom right.

The columns of U can be referred to as left singular vectors (m vectors) of Y. The columns of V, i.e. the rows of V^{T}, on the other hand, can be referred to as right singular vectors (n vectors) of Y. The diagonal entries of S can be referred to as singular values σ₁ of Y. The leftmost or top right singular vector can be linked to the largest singular value σᵢ, the singular vector to the right of the leftmost or below the top right can be linked to the second largest singular value σ₁ and so on.

A dominant singular value σ_{d,i} can be a value significantly different from zero, for example, whereas a non-dominant singular value σ_{nd,i} can be zero or a value near zero.

These methods of the present invention can be used to determine optimal basis functions for describing trajectories by means of linear combination. The singular value decomposition enables a low-rank approximation. The methods of the present invention are thus easy to implement and provide good approximation results.

The obtained optimized basis functions can be used offline, for example to support function design in the development process, and/or online, for example for the subsequent adaptation of a subspace relevant to the respective optimization.

Definition data that encodes the optimized basis functions or a subspace span(U_{d}) and/or span(AU_{d}) relevant to a trajectory optimization can be provided offline, for instance, and used in a method executed online by a processor in a vehicle or robot. The definition data can be used to parameterize an optimizer that runs or is intended to run on a control device of the vehicle or robot, for example.

Continuously updating the optimized basis functions in the vehicle or robot, for example on the basis of current sensor data generated by a sensor system of the vehicle or robot while driving, is possible as well.

When determining the optimized basis functions, a variety of optimization criteria can be taken into account, for instance, which can also be weighted differently. Examples of such optimization criteria include an accuracy of mapping of the reference data, a smallest degree of the polynomial or a smoothness of the derivatives.

In addition to the mathematical optimality of the basis functions determined in this way, the approach presented here also provides guarantees for the quality of the approximation in the form of p norms or weighted p norms. This is particularly useful for being able to systematically verify the fulfillment of requirements.

Using the predefined basis function(s) makes it possible to restrict the optimized basis functions to be determined to one or more types such as polynomials, splines, trigonometric functions, Bessel functions or combinations thereof. The computational efficiency of the method can thus be improved significantly. The method can accordingly be implemented at lower cost. If the basis functions to be determined automatically by the method are restricted from the outset to one or more types, this means that solutions of the optimal approximation are likewise provided in accordance with said specific form(s) of description. Such solutions can be optimal degrees of polynomials, for example. The restriction to fundamental classes of basis functions makes it possible to simplify the use of the obtained optimized basis functions in a subsequent trajectory optimization.

A third aspect of the present invention relates to a computer-implemented method for estimating trajectories. According to an example embodiment of the present invention, the method comprises at least the following steps: receiving sensor data generated by a sensor system of a vehicle in a plurality of successive time steps; and determining at least one estimated trajectory from the sensor data of different time steps using optimized basis functions determined by means of one of the methods for determining optimized basis functions described above and in the following.

A fourth aspect of the present invention relates to a computer-implemented method for controlling an actuation system of a vehicle. According to an example embodiment of the present invention, the method comprises at least the following steps: determining at least one estimated trajectory using one of the methods for determining optimized basis functions described above and in the following; and generating a control command for controlling the actuation system as a function of the at least one estimated trajectory.

The four aforementioned methods can be carried out automatically by a processor.

The processor can be part of a control device of a vehicle, for example.

For instance, a driver assistance system can run on the control device, which can be configured to determine an estimated position and/or orientation of the vehicle relative to objects in the surroundings of the vehicle in a plurality of successive time steps, i.e. estimate a current trajectory of the vehicle, and to control the vehicle, for example steer, accelerate and/or slow down, such that the current trajectory approaches a specific target trajectory.

For this purpose, the vehicle can be equipped with a corresponding actuation system, which can, for example, include a brake actuator, a steering actuator, an engine control device, an electric drive motor or a combination of at least two of these examples.

The sensor system can comprise a camera, a radar, LiDAR, ultrasound, acceleration, wheel speed or steering wheel angle sensor. for example, or a combination of at least two of these examples.

Above and in the following, “vehicle” can be understood to mean a car, truck, bus or motorcycle, for instance. In a broader sense, “vehicle” can also be understood above and in the following to mean an autonomously moving robot.

A fifth aspect of the present invention relates to a data processing device comprising a processor configured to carry out at least one of the methods described above and in the following.

The data processing device can comprise hardware and/or software modules. In addition to the processor, the data processing device can comprise a memory and data communication interfaces for data communication with peripheral devices. The data processing device can be a control device of a vehicle (or robot), a PC, server, laptop, tablet or smartphone, for example.

Features of the methods of the present invention described above and in the following can also be considered features of the data processing device, and vice versa.

Further aspects of the present invention relate to a computer program and a computer-readable medium on which the computer program is stored.

The computer program comprises instructions that, when the computer program is executed by a processor, prompt said processor to carry out at least one of the methods described above and in the following.

The computer-readable medium can be a volatile or non-volatile data memory. The computer-readable medium can be a hard drive, a USB memory device, a RAM, ROM, EPROM or flash memory, for example. The computer-readable medium can also be a data communication network such as the Internet or a data cloud, which enables downloading a program code.

Features of the methods of the present invention described above and in the following can also be considered features of the computer program and/or computer-readable medium, and vice versa.

Embodiments of the present invention can be considered, without limiting the present invention, to be based on the ideas and insights described in the following.

According to one example embodiment of the present invention, the at least one predefined basis function can be a fifth-degree or lower polynomial. It has been shown that such polynomials enable a particularly efficient and sufficiently accurate approximation of trajectories in certain applications. However, higher degree polynomials are possible as well.

According to one example embodiment of the present invention, the reference data can comprise sensor data generated by a sensor system of at least one vehicle and/or geodata.

The sensor data can include measured values for a position, orientation, speed, and/or acceleration of the vehicle and/or objects in the surroundings of the vehicle, for instance. Additionally, or alternatively, the sensor data can include coordinates determined using a global navigation satellite system, such as GPS or GLONASS. The sensor data can be from the same vehicle in which the optimized basis functions are to be used later, or from different vehicles. The geodata can be data stored in a digital map of a possible environment of a vehicle (e.g. OpenStreetMap). The geodata can, for instance, encode a topology of the surroundings, road courses, buildings, vegetation, traffic signs, traffic rules or combinations thereof.

In this way, particularly suitable reference data can be provided for a low-rank approximation.

According to one example embodiment of the present invention, the singular values σᵢ can be sorted in descending order of magnitude. Starting from the largest singular value σᵢ, a defined number of the sorted singular values σᵢ can then be selected as the dominant singular values σ_{d,i}. In other words, the dominant singular values σ_{d,i} can be the largest entries of S that differ sufficiently from the remaining non-dominant entries σ_{nd,i} of S. The dominant singular values can thus be determined particularly efficiently.

Carrying out the singular value decomposition can include the following calculation steps, for example.

$$Calculating Y = {USV}^{T} .$$

Selecting the top k right singular vectors by setting

$${V}_{k}^{T}$$

equal to the first k rows of V^{T} (k×n matrix).

Selecting the top k left singular vectors by setting Uₖ equal to the first k columns of U (m×k matrix).

Selecting the top k singular values by setting Sₖ equal to the first k rows and columns of S (k×k matrix) which correspond to the k largest singular values of Y.

Calculating the rank k approximation with

$${Y}_{k} = {U}_{k} {S}_{k} {V}_{k}^{T} = \tilde{Y} .$$

In the determination of the low-rank approximation, the target rank k can be used as a parameter. For example, k can be set equal to the number of singular values significantly different from zero, i.e. largest singular values. In this case, k can be selected such that the sum of the largest k singular values is at least c times the sum of the remaining singular values. The constant c can be range-dependent and can be between 10 and 100, for example. The value k can be selected as small as possible, as long as this does not worsen the approximation.

According to one example embodiment of the present invention, the optimized basis functions can have been determined using the method according to the first aspect of the present invention. The at least one estimated trajectory can then be determined as a result of a trajectory optimization in a subspace span(U_{d}) that is spanned by the basis vectors in U_{d}.

According to one example embodiment of the present invention, the optimized basis functions can have been determined using the method according to the second aspect of the present invention. The at least one estimated trajectory can then be determined as a result of a trajectory optimization in a subspace span(AU_{d}) that is spanned by the basis vectors in U_{d} multiplied by the matrix A.

### BRIEF DESCRIPTION OF THE DRAWINGS

Embodiments of the present invention are described in the following with reference to the figures, wherein neither the figures nor the description are to be construed as limiting the present invention.

FIG. 1 shows a vehicle comprising a control device for carrying out a method according to one embodiment of the present invention.

FIG. 2 shows a diagram illustrating a possible trajectory to be approximated in a method according to one example embodiment of the present invention.

FIG. 3 shows a diagram illustrating a plurality of normalized possible trajectories to be approximated in a method according to one embodiment of the present invention.

FIG. 4 shows a distribution of singular values determined in a method according to one embodiment of the present invention.

FIG. 5 shows two diagrams illustrating basis functions determined in a method according to one embodiment of the present invention.

FIG. 6 shows three diagrams illustrating the approximation of trajectories in subspaces determined using a method according to one embodiment of the present invention.

The figures are merely schematic and are not to scale. Identical reference signs in the figures denote identical or functionally identical features.

### DETAILED DESCRIPTION OF EXAMPLE EMBODIMENTS

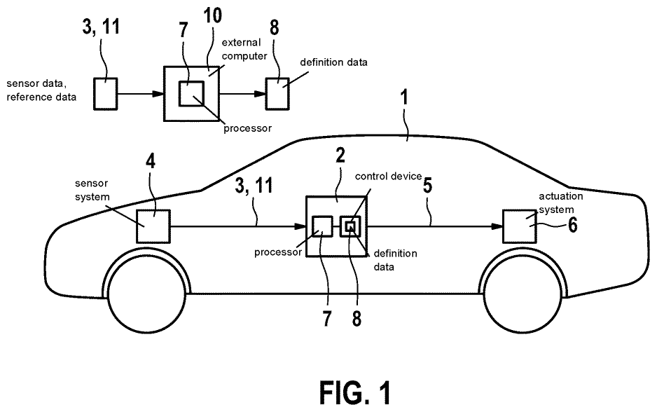

FIG. 1 shows a vehicle 1 comprising a data processing device in the form of a control device 2, which is configured to generate control commands 5 for controlling an actuation system 6 of the vehicle 1 from sensor data 3 produced by a sensor system 4 of the vehicle 1.

The sensor system 4 can comprise a camera, a radar, LiDAR, ultrasound, acceleration, wheel speed or steering wheel angle sensor. for example, or a combination of at least two of these examples.

The actuation system 6 can include a brake actuator, a steering actuator, an engine control device, an electric drive motor, for example, or a combination of at least two of these examples.

The control device 2 comprises a processor 7 configured to execute a computer program by means of which a method for controlling the actuation system 6 is carried out as described in more detail in the following.

In a first step, the sensor data 3 is received in the control device 2 in a plurality of successive time steps.

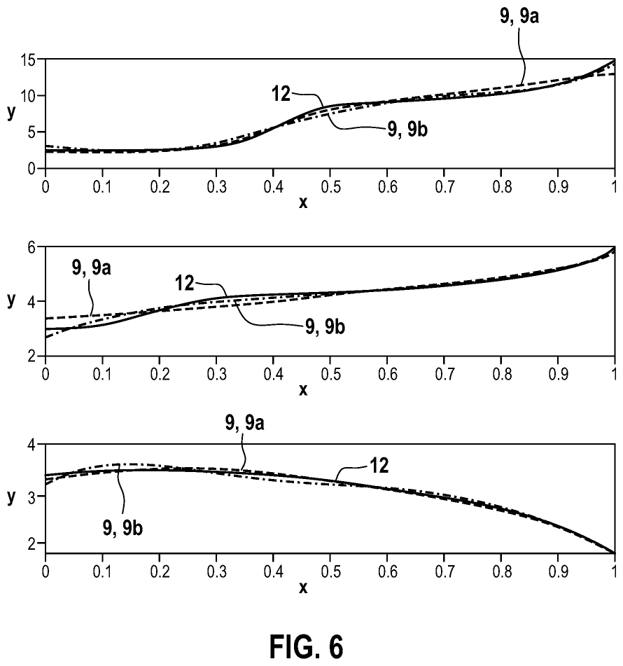

In a second step, in each current time step, at least one estimated trajectory 9 of the vehicle 1 (see FIG. 6) is determined for at least one future time step from the sensor data 3 of the current and at least one previous time step using definition data 8 which define a subspace span(U_{d}) or span(AU_{d}) (see below).

In a third step, the control commands 5 can then be generated such that the estimated trajectory 9 approaches a specific target trajectory that the vehicle 1 is to follow by corresponding actuation of the actuation system 6.

The definition data 8 can have been generated by a data processing device in the form of an external computer 10 comprising a processor 7 (see FIG. 1), for example a PC, server, laptop, tablet or smartphone, and/or by the control device 2 in a method as described in more detail in the following.

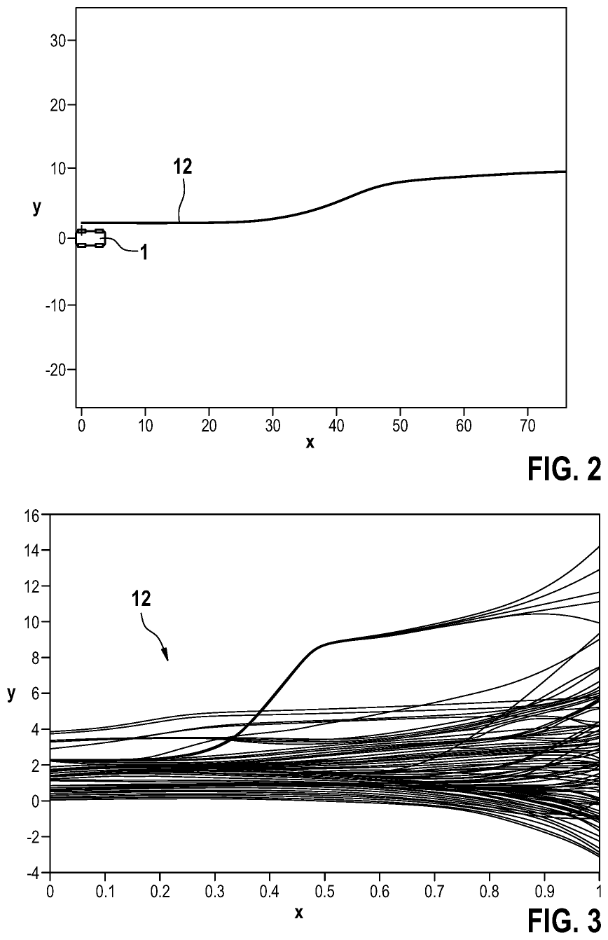

In a first step, the computer 10 or the control device 2 receives reference data 11 which encodes possible trajectories 12 (see FIG. 2 and FIG. 3).

In a second step, the reference data 11 is preprocessed and the preprocessed reference data 11 is aggregated in a matrix Y.

In a third step, a singular value decomposition Y=USV^{T} is calculated with a diagonal singular value matrix σᵢ containing singular values S, a matrix U of left singular vectors, and a matrix V of right singular vectors.

In a fourth step, at least one of the singular values σᵢ is identified as a dominant singular value σ_{d,i} and at least one other of the singular values σᵢ is identified as a non-dominant singular value σ_{nd,i}.

For this purpose, the singular values σᵢ can be sorted in descending order of magnitude, for example. Starting from the largest singular value σᵢ, a defined number of the sorted singular values σᵢ can then be selected as the dominant singular values σ_{d,i}.

In a fifth step, a matrix U_{d} is determined, which comprises dominant (left) singular vectors assigned to the dominant singular values σ_{d,i}, wherein the optimized basis functions are described by these dominant singular vectors. The definition data 8 can accordingly include the matrix U_{d}.

Alternatively, at least one predefined basis function is aggregated in a matrix A in an additional step. The at least one predefined basis function is a fifth-degree or lower polynomial, for example. However, other types of functions also possible as well.

In the third step, then, a singular value decomposition P=(A^{T}A)⁻¹A^{T}Y=USV^{T} is alternatively calculated.

Accordingly, in a fourth step, similar to the method described above, at least one of the singular values σᵢ is identified as the dominant singular value σ_{d,i} and at least one other of the singular values σᵢ is identified as the non-dominant singular value σ_{nd,i}.

Lastly, in the fifth step, a matrix product AU_{d} is determined from the matrix A and a matrix U_{d} which comprises the dominant (left) singular vectors assigned to the dominant singular values σ_{d,i}. The optimized basis functions are described by the matrix product AU_{d}. In this case, therefore, the definition data 8 can include the matrix product AU_{d}.

Thus, the estimated trajectory 9 can be determined and/or optimized by an approximation in the subspace span(U_{d}) or span(AU_{d}).

The method can proceed as follows, for example.

First, the reference data 11 relevant to the particular optimization problem is received and preprocessed. The reference data 11 can include sensor data 3 generated by a sensor system 4 of one or more vehicles 1, for example, and/or geodata that can be preprocessed accordingly. It is possible for the reference data 11 to be provided by the sensor system 4 itself. Alternatively, the reference data 11 can be provided by the computer 10 or the control device 2. Possible applications are, for instance, displaying an absolute or relative target path or a target trajectory. The important thing is that the reference data 11 is preprocessed in accordance with the application.

The (preprocessed) reference data 11 can be stacked column-wise in the matrix Y:

$$Y = [ {y}_{1} … {y}_{n} ] .$$

The matrix Y can now be decomposed with a singular value decomposition into singular values ai which are arranged diagonally in the singular value matrix S, and left or right singular vectors which are stacked column-wise in the matrix U or V:

$$Y = {USV}^{T} ,$$

$${U}^{T} U = I ,$$

$$S = diag ( {σ}_{i} ) ,$$

$${V}^{T} V = I .$$

After determining the matrix U_{d} or V_{d}, which refers to the dominant, i.e. largest, singular values, and a matrix U_{nd} or V_{nd}, which contains the remaining (non-dominant) singular vectors, the result is

$$Y = {U}_{d} {S}_{d} {V}_{d}^{T} + {U}_{nd} {S}_{nd} {V}_{nd}^{T} ,$$

$${S}_{1} = diag ( {σ}_{d , i} ) ,$$

$${S}_{2} = diag ( {σ}_{nd , j} ) .$$

A low-rank approximation is obtained by orthogonal projection onto span(U_{d}):

$$\tilde{Y} = {U}_{d} {S}_{d} {V}_{d}^{T} = {{U}_{d} ( {U}_{d}^{T} {U}_{d} )}^{- 1} {U}_{d}^{T} Y .$$

According to the Eckart-Young-Mirsky theorem, the approximation error is:

$${‖ Y - \tilde{Y} ‖}_{F} = {‖ {U}_{nd} {S}_{nd} {V}_{nd}^{T} ‖}_{F} = {‖ {σ}_{nd} ‖}_{2} = \sqrt{{σ}_{nd , j}^{2}} ,$$

$${‖ Y - \tilde{Y} ‖}_{2} = {‖ {U}_{nd} {S}_{nd} {V}_{nd}^{T} ‖}_{2} = {‖ {σ}_{nd} ‖}_{∞} = max ( {σ}_{nd} ) .$$

This provides a mathematical guarantee for the error norm of the approximation, which in turn allows the required accuracy to be predefined. Eckart, Young and Mirsky furthermore prove that the singular value decomposition is the optimal low-rank approximation for the Frobenius norm and the 2 norm.

There are often constraints that have to be satisfied, for instance due to given interfaces in the software implementation. In such a case, it is possible to determine a predefined space span(A), in which admissible predefined basis vectors are stacked column-wise in a matrix A. These can be polynomials, splines, trigonometric functions, other interpolating curves and/or discrete curves, for example.

If the coefficients for these basis functions are stacked in P=[p₁, p₂, p₃ . . . ], the result is

$$AP \approx Y ,$$

$$P \approx {( {A}^{T} A )}^{- 1} {A}^{T} Y = {USV}^{T} = {U}_{d} {S}_{d} {V}_{d}^{T} + {U}_{nd} {S}_{nd} {V}_{nd}^{T} ,$$

wherein the singular value decomposition is carried out in a similar manner to as described above.

The low-rank approximation is then obtained by orthogonal projection onto span(AU_{d}):

$$\tilde{Y} = {{AU}_{d} ( {( {AU}_{d} )}^{T} {AU}_{d} )}^{- 1} {( {AU}_{d} )}^{T} Y .$$

It must be noted that span(AU_{d}) is generally not an orthogonal basis. If necessary, this can be remedied by a Gram-Schmidt orthogonalization.

The above-described algorithms can be applied to recorded data describing a continuously estimated course of a lane marking in discrete form, for example. However, it should be noted that the algorithm can be applied to any curve, for example also to the time profile of longitudinal speed of a vehicle.

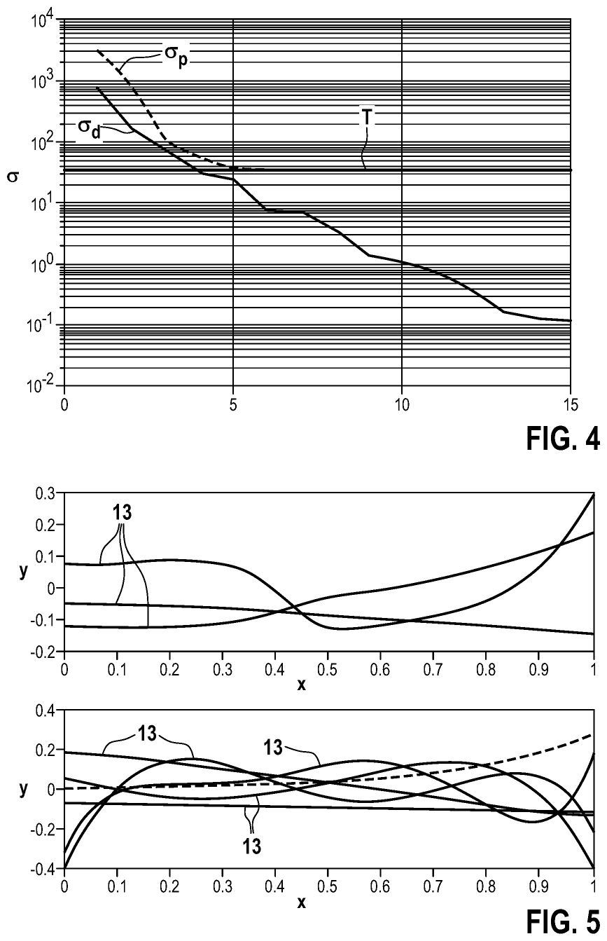

FIG. 4 shows an example of a distribution of singular values σ_{d}, σₚ from a singular value decomposition of the reference data 11. As an example, the permissible approximation quality was set in both cases here to a tolerance T of 35. The singular values σₚ result from a singular value decomposition in which fifth-degree polynomials and lower were used as predefined basis functions for the algorithm. The singular values σ_{d} result from a singular value decomposition of discrete data in which restriction was placed on specific predefined basis functions.

The upper diagram in FIG. 5 illustrates three basis functions 13 that result when the singular values σ_{d} are used to generate the definition data 8.

The lower diagram in FIG. 5 illustrates five basis functions 13 that result when the singular values σₚ are used to generate the definition data 8.

It can be seen that, if there are no constraints, it is indeed possible to generate a smaller set of “arbitrary” basis functions (see top diagram), but, due to the less smooth, discrete representation, the more difficult interpretability and the more difficult determination of the derivatives, this comes at the price of a potentially more complex implementation.

The basis functions 13 determined in this way can, for example, also be interpreted as optimal sets of motion primitives if the application consists of following the course of the lane for a given data set. For the algorithm to develop its full potential, the quantity of reference data 11 should be correspondingly large.

FIG. 6 shows three diagrams, in each of which a first estimated trajectory 9a determined using the basis functions 13 from the singular values σ_{d} and a second estimated trajectory 9b determined using the basis functions 13 from singular values σₚ are compared with a to-be-approximated recorded estimated trajectory 12 in order to be able to estimate the approximation quality of the low-rank approximation. It can be seen that the approximation is similarly good in all cases.

Lastly, it should be noted that terms such as “comprising,” “including” etc. do not exclude other elements or steps, and indefinite articles such as “a” or “an” do not exclude a plurality.

What is claimed is:

1. A computer-implemented method for determining optimized basis functions for describing trajectories, the method comprising the following steps:
receiving reference data which describes possible trajectories;
preprocessing the reference data, wherein the reference data is aggregated in a matrix Y;
carrying out a singular value decomposition Y=USV^{T}, wherein the matrices U and V each include singular vectors and S is a diagonal singular value matrix with singular values σᵢ;
identifying at least one of the singular values σᵢ as a dominant singular value of a plurality of dominant singular values σ_{d,i} and at least one other of the singular values σᵢ as a non-dominant singular value σ_{nd,i}; and
determining a matrix U_{d} which includes dominant singular vectors assigned to the dominant singular values σ_{d,i}, wherein the optimized basis functions are described by the dominant singular vectors.

2. The method according to claim 1, wherein the reference data include sensor data generated by a sensor system of at least one vehicle and/or geodata.

3. The method according to claim 1, wherein the singular values σᵢ are sorted in descending order of magnitude and, starting from a largest singular value σᵢ, a defined number of the sorted singular values σᵢ are selected as the dominant singular values σ_{d,i}.

4. The method according to claim 3, wherein the defined number is a target rank k selected such that a sum of k largest singular values of the sorted singular values is at least c times a sum of remaining singular values of the sorted singular values, wherein c is between 10 and 100.

5. The method according to claim 1, wherein the singular values σᵢ are sorted in descending order of magnitude and, based on a defined cutoff value, all singular values σᵢ that are greater than the cutoff value or equal to the cutoff value are selected as the dominant singular values σ_{d,i}.

6. The method according to claim 5, wherein the cutoff value is selected a priori such that a desired approximation quality is guaranteed in accordance with an Eckart-Young-Mirsky theorem.

7. The method according to claim 1, wherein preprocessing the reference data includes extracting travel lanes from the reference data as potential trajectories to be approximated and at least one of scaling, weighting, or trimming the potential trajectories to a common length.

8. A computer-implemented method for determining optimized basis functions for describing trajectories, the method comprising the following steps:
receiving reference data which describes possible trajectories;
preprocessing the reference data, wherein the reference data is aggregated in a matrix Y;
aggregating at least one predefined basis function in a matrix A;
carrying out a singular value decomposition P=(A^{T}A)⁻¹A^{T}Y=USV^{T}, wherein the matrices U and V each include singular vectors and S is a diagonal singular value matrix with singular values σᵢ;
identifying at least one of the singular values σᵢ as a dominant singular value of a plurality of dominant singular values σ_{d,i} and at least one other of the singular values σᵢ as a non-dominant singular value σ_{nd,i}; and
determining a matrix product AU_{d} by multiplying the matrix A by a matrix U_{d} which includes dominant singular vectors assigned to the dominant singular values σ_{d,i}, wherein the optimized basis functions are described by the matrix product AU_{d}.

9. The method according to claim 8, wherein the at least one predefined basis function is a fifth-degree or lower polynomial.

10. The method according to claim 8, wherein the at least one predefined basis function includes a spline, a trigonometric function, a Bessel function, an interpolating curve, a discrete curve, or a combination thereof.

11. A computer-implemented method for estimating trajectories, the method comprising the following steps:
receiving sensor data generated by a sensor system of a vehicle in a plurality of successive time steps; and
determining at least one estimated trajectory from the sensor data of different time steps using optimized basis functions determined by:
receiving reference data which describes possible trajectories,
preprocessing the reference data, wherein the reference data is aggregated in a matrix Y,
carrying out a singular value decomposition Y=USV^{T}, wherein the matrices U and V each include singular vectors and S is a diagonal singular value matrix with singular values σᵢ,
identifying at least one of the singular values σᵢ as a dominant singular value of a plurality of dominant singular values σ_{d,i} and at least one other of the singular values σᵢ as a non-dominant singular value σ_{nd,i}, and
determining a matrix U_{d} which includes dominant singular vectors assigned to the dominant singular values σ_{d,i}, wherein the optimized basis functions are described by the dominant singular vectors.

12. The method according to claim 11, wherein the at least one estimated trajectory is determined as a result of trajectory optimization in a subspace span (U_{d}).

13. The method according to claim 11, wherein the at least one estimated trajectory is determined, in each current time step, for at least one future time step from the sensor data of a current time step and of at least one previous time step.

14. A computer-implemented method for estimating trajectories, the method comprising the following steps:
receiving sensor data generated by a sensor system of a vehicle in a plurality of successive time steps; and
determining at least one estimated trajectory from the sensor data of different time steps using optimized basis functions determined by:
receiving reference data which describes possible trajectories,
preprocessing the reference data, wherein the reference data is aggregated in a matrix Y,
aggregating at least one predefined basis function in a matrix A,
carrying out a singular value decomposition P=(A^{T}A)⁻¹A^{T}Y=USV^{T}, wherein the matrices U and V each include singular vectors and S is a diagonal singular value matrix with singular values σᵢ,
identifying at least one of the singular values σᵢ as a dominant singular value of a plurality of dominant singular values σ_{d,i} and at least one other of the singular values σᵢ as a non-dominant singular value σ_{nd,i}, and
determining a matrix product AU_{d} by multiplying the matrix A by a matrix U_{d} which includes dominant singular vectors assigned to the dominant singular values σ_{d,i}, wherein the optimized basis functions are described by the matrix product AU_{d}.

15. The method according to claim 14, wherein the at least one estimated trajectory is determined as a result of trajectory optimization in a subspace span (AU_{d}).

16. The method according to claim 15, wherein basis vectors of the matrix product AU_{d} are orthogonalized using a Gram-Schmidt orthogonalization before the trajectory optimization is performed.

17. A computer-implemented method for controlling an actuation system of a vehicle, the method comprising the following steps:
determining at least one estimated trajectory by:
receiving sensor data generated by a sensor system of a vehicle in a plurality of successive time steps; and
determining at least one estimated trajectory from the sensor data of different time steps using optimized basis functions determined by:
receiving reference data which describes possible trajectories,
preprocessing the reference data, wherein the reference data is aggregated in a matrix Y,
carrying out a singular value decomposition Y=USV^{T}, wherein the matrices U and V each include singular vectors and Sis a diagonal singular value matrix with singular values σᵢ,
identifying at least one of the singular values σᵢ as a dominant singular value of a plurality of dominant singular values σ_{d,i} and at least one other of the singular values σᵢ as a non-dominant singular value σ_{nd,i}, and
determining a matrix U_{d} which includes dominant singular vectors assigned to the dominant singular values σ_{d,i}, wherein the optimized basis functions are described by the dominant singular vectors; and
generating a control command for controlling the actuation system as a function of the at least one estimated trajectory.

18. The method according to claim 17, wherein:
the control command is generated such that the at least one estimated trajectory approaches a target trajectory to be followed by the vehicle by corresponding actuation of the actuation system; and
the actuation system includes a brake actuator, a steering actuator, an engine control device, an electric drive motor, or a combination thereof.

19. A data processing device, comprising:
a processor configured to determine optimized basis functions for describing trajectories, the processor configured to:
receive reference data which describes possible trajectories;
preprocess the reference data, wherein the reference data is aggregated in a matrix Y;
carry out a singular value decomposition Y=USV^{T}, wherein the matrices U and V each include singular vectors and S is a diagonal singular value matrix with singular values σᵢ;
identify at least one of the singular values σᵢ as a dominant singular value of a plurality of dominant singular values σ_{d,i} and at least one other of the singular values σᵢ as a non-dominant singular value σ_{nd,i}; and
determine a matrix U_{d} which includes dominant singular vectors assigned to the dominant singular values σ_{d,i}, wherein the optimized basis functions are described by the dominant singular vectors.

20. A non-transitory computer-readable medium on which is stored a computer program for determining optimized basis functions for describing trajectories, the computer program, when executed by a computer, causing the computer to perform the following steps:
receiving reference data which describes possible trajectories;
preprocessing the reference data, wherein the reference data is aggregated in a matrix Y;
carrying out a singular value decomposition Y=USV^{T}, wherein the matrices U and V each include singular vectors and S is a diagonal singular value matrix with singular values σᵢ;
identifying at least one of the singular values σᵢ as a dominant singular value of a plurality of dominant singular values σ_{d,i} and at least one other of the singular values σᵢ as a non-dominant singular value α_{nd,i}; and
determining a matrix U_{d} which includes dominant singular vectors assigned to the dominant singular values σ_{d,i}, wherein the optimized basis functions are described by the dominant singular vectors.
